(19) United States
(12) Patent Application Publication
(10) Pub. No.: US 2025/0028612 A1
(43) Pub. Date: Jan. 23, 2025

(54) I/O FAILOVER USING ADAPTER FIRMWARE

(71) Applicant: INTERNATIONAL BUSINESS MACHINES CORPORATION, ARMONK, NY (US)

(72) Inventors: PHANI KUMAR V. U. AYYAGARI, HYDERABAD (IN); YADAGIRI RAJABOINA, HYDERABAD (IN)

(21) Appl. No.: 18/355,808

(22) Filed: Jul. 20, 2023

(51) Int. Cl. G06F 11/20; G06F 11/14; G06F 11/30

(52) U.S. Cl. CPC G06F 11/2033; G06F 11/1417; G06F 11/3075

(57) ABSTRACT

Methods, systems, and products for I/O failover includes: receiving, by a host driver, a registered state change notification (RSCN) for a target storage port, issuing, by the host driver, a query for a state of the target storage port, reissuing, by the host driver and responsive to the query failing, the query a predefined number of times, and sending, by the host driver to a host bus adapter (HBA) firmware and responsive to the reissued queries failing, a mailbox command to store failure statistics related to the target storage port.

### BACKGROUND

### Field of the Disclosure

The field of the disclosure is data processing, or, more specifically, methods, systems, and products for I/O failover.

### Description Of Related Art

A storage area network (SAN) is a computer network which provides access to block-level data storage, which may be within data storage devices. A SAN may be a dedicated network of storage devices not accessible through the local area network (LAN). In computer storage, multipath I/O (input/output) is a fault-tolerance and performance-enhancement technique that defines more than one physical path between the CPU in a computer system and its mass-storage devices through the buses, controllers, switches, and bridge devices connecting them. In an example where a SCSI hard disk drive is connected to two SCSI controllers, or to two Fibre Channel (FC) ports on the same computer, if one controller or port fails, the operating system can route the I/O through the remaining controller or port transparently and with no changes visible to the applications.

When a storage port is removed from the SAN, the Fabric notifies the registered hosts with Registered State Change Notification (RSCN), which the hosts then respond to by querying, by the FC drivers, the state of that storage port multiple times for a predefined number of times before finally failing the I/O over to another storage port. In the case where a storage port (such as an FC port) is faulty, due to a faulty cable or SFP (small form-factor pluggable), the storage port may frequently become removed from the SAN and later try to reconnect, causing the lengthy failover process to occur every time the storage port is removed from the SAN.

### SUMMARY

Methods and systems for I/O failover according to various embodiments are disclosed in this specification. In accordance with one aspect of the present disclosure, a method of I/O failover may include receiving, by a host driver, a registered state change notification (RSCN) for a target storage port, issuing, by the host driver, a query for a state of the target storage port, reissuing, by the host driver and responsive to the query failing, the query a predefined number of times, and sending, by the host driver to a host bus adapter (HBA) firmware and responsive to the reissued queries failing, a mailbox command to store failure statistics related to the target storage port.

In accordance with another aspect of the present disclosure, I/O failover may include a system including: a processor, and computer memory comprising computer program instructions that, when executed cause the system to: receive, by a host driver, a registered state change notification (RSCN) for a target storage port, issue, by the host driver, a query for a state of the target storage port, reissue, by the host driver and responsive to the query failing, the query a predefined number of times, and send, by the host driver to a host bus adapter (HBA) firmware and responsive to the reissued queries failing, a mailbox command to store failure statistics related to the target storage port.

The foregoing and other objects, features and advantages of the disclosure will be apparent from the following more particular descriptions of exemplary embodiments of the disclosure as illustrated in the accompanying drawings wherein like reference numbers generally represent like parts of exemplary embodiments of the disclosure.

### BRIEF DESCRIPTION OF THE DRAWINGS

FIG. 1 shows an example line drawing of a system configured for I/O failover in accordance with embodiments of the present disclosure.

FIG. 2 is a flowchart of an example method for I/O failover according to some embodiments of the present disclosure.

FIG. 3 is a flowchart of an example method for I/O failover according to some embodiments of the present disclosure.

### DETAILED DESCRIPTION

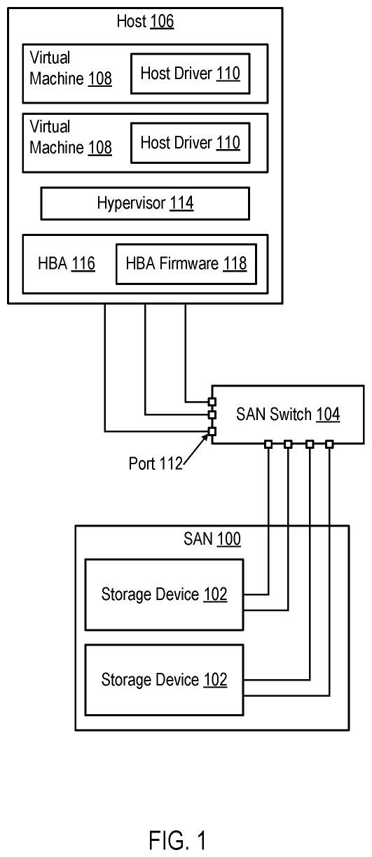

Exemplary methods, systems, and products for I/O failover in accordance with the present disclosure are described with reference to the accompanying drawings, beginning with FIG. 1. FIG. 1 sets forth an example system configured for I/O failover in accordance with embodiments of the present disclosure. The example system of FIG. 1 includes a host 106, a SAN switch 104, and a SAN 100.

The example host 106 of FIG. 1 includes one or more virtual machines 108, a hypervisor 114, and an HBA 116. The one or more virtual machines 108 each includes a host driver 110 and an operating system (not shown in FIG. 1). The hypervisor 114 is a type of computer software, firmware or hardware that creates and manages the execution of the virtual machines. The HBA 116 is configured to connect the host 106 to other network and storage devices, such as the SAN switch 104 and the SAN 100 and its included storage devices 102. The HBA includes HBA firmware 118 configured to boot and run the HBA during normal operation. The example HBA of FIG. 1 is configured to communicate with storage devices using Fibre Channel (FC), which is a high-speed data transfer protocol providing in-order, lossless delivery of raw block data.

The example SAN 100 of FIG. 1 is a high-speed network that provides network access to storage devices 102 included within the SAN. The SAN 100 includes multiple storage devices 102 each configured to communicate using FC.

The example SAN switch 104 of FIG. 1 is configured to connect the host 106 to the SAN 100 and its included storage devices 102. The SAN switch includes multiple ports 112, where each port may be configured as an FC storage port. Each storage port provides a pathway for I/O to travel between the host 106 and the SAN 100. That is, a storage port provides access to the SAN switch and to each of the storage devices within the SAN. The example SAN switch of FIG. 1 is configured to provide a multipathing environment that allows for multiple pathways, using multiple different ports, between the host and any given storage device 102 within the SAN. Such a multipathing environment allows the host to access any storage device even when one or more pathways between the host and the storage device is faulty (for example, due to a faulty cable or SFP). The multipath environment may extend to both sides of the switch, where there may be multiple pathways between the host and the SAN switch, as well as multiple pathways between the SAN switch and each storage device within the SAN. In one embodiment, there are multiple other SAN switches (not shown in FIG. 1) included within the SAN.

The SAN switch may utilize a name service database, such as a Fabric Nameserver within the FC fabric (not shown in FIG. 1), to store information about registered nodes, such as the storage devices within the SAN, on the local switch and on remote switches in the fabric. The SAN switch is configured to send Registered State Change Notifications (RSCNs) to hosts, including any virtual machines within the hosts, to inform them of any node information changes (for example, such as node registration, node deregistration, or registration information changes). An RSCN may include only the FC address of the node where the change occurred. For example, an RSCN sent in reference to a storage device 102 may include the N_PORT ID of the particular storage port associated with the storage device where the change occurred. When a change occurs, the SAN switch sends Extended Link Service (ELS) RSCNs to its concerned registered nodes. After receiving an RSCN, a switch or node automatically sends a name service query (to the Fabric Nameserver) to obtain the new information (i.e. N_PORT ID using WWPN). The switch receiving an RSCN also sends ELS_RSCNs to notify their concerned registered nodes. As a result, the changed information is notified and updated throughout the fabric.

The example host drivers may be configured to instruct the HBA firmware 118 to store failure statistics in response to a storage port failing. These failure statistics, obtained from previous attempts to access a storage port, may be leveraged by any virtual machine or host driver on host 106, to determine whether to failover I/O to another pathway using a different storage port, thereby decreasing failover time, and increasing efficiency. In other embodiments, the failure statistics may be used during a boot process to decrease failover time and thereby increase boot efficiency. The HBA firmware includes a mechanism to store, retrieve, or clear failure statistics about any particular storage port within the SAN as instructed by a host driver.

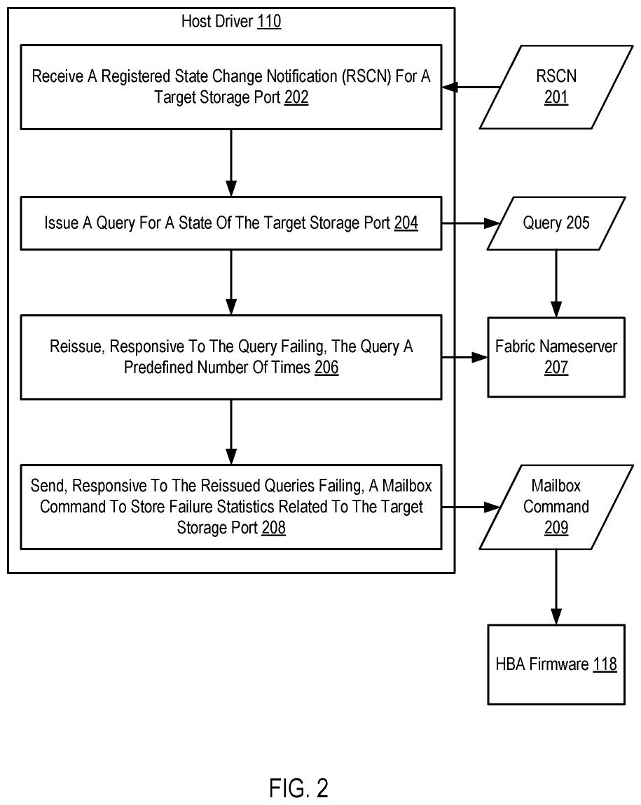

For further explanation, FIG. 2 sets forth a flow chart illustrating an exemplary method of I/O failover according to embodiments of the present disclosure. The method of FIG. 2 includes receiving 202 a registered state change notification (RSCN) for a target storage port. Receiving 202 an RSCN 201 for a target storage port may be carried out by the host driver 110 receiving the RSCN from the FC fabric in response to the storage port leaving the SAN. For example, if a FC storage port is removed from the SAN, such as due to a faulty port, the SAN switch sends an RSCN to each host driver in the fabric notifying the host of the storage port leaving the fabric. The RSCN is a notification sent by the switch on FC fabric to notify of a node changes. The RSCN may include only the FC address of the node or port where the change occurred.

The method of FIG. 2 also includes issuing 204 a query for a state of the target storage port. Issuing 204 a query 205 for a state of the target storage port may be carried out by the host driver 110 sending a query, such as a Fibre channel Common Transport Unit (CT_IU) called Get Port Identifier (GID_PN), to a Fabric Nameserver 207 within the FC fabric (not shown in FIG. 1). The Fabric Nameserver 207 may include a database storing information about registered nodes on the local switch and on remote switches in the FC fabric. The nameserver may include the status of every node within fabric and may be provided to a host in response to a query. The query 205 may be issued automatically in response to the host driver receiving the RSCN indicating the target storage port had a status change in order to obtain the status change information.

The method of FIG. 2 also includes reissuing 206, responsive to the query failing, the query a predefined number of times. Reissuing 206 the query 205 may be carried out by the host driver 110 in response to the query failing or indicating that the target storage port has not joined the SAN. For example, the host driver 110 may receive a response to its issued GID_PN query indicating that the target storage port is not joined to the SAN and then wait a predetermined amount of time, such as R_A_TOV (Resource Allocation TimeOut Value) before re-attempting the query 205 to retrieve the status of the target storage port. In some embodiments, the host driver may re-issue the query multiple times before eventually utilizing the multipath environment and failing over the I/O to another storage port.

The method of FIG. 2 also includes sending 208, responsive to the reissued queries failing, a mailbox command to store failure statistics related to the target storage port. Sending 208 a mailbox command 209 may be carried out by the host driver 110 sending the mailbox command to the HBA (host bus adapter) firmware 118 in response to the reissued queries indicating that the target storage port still has not joined the SAN. The HBA firmware may be configured to receive mailbox commands. The mailbox command 209 may include instructions to store failure statistics related to the target storage port. In one embodiment, the mailbox command may have a ‘set’ bit enabled, indicating that the mailbox command includes failure statistics that should be stored related to the target storage port. The failure statistics may include the number of retry attempts (such as the number of queries 205 attempting to retrieve status information of the target storage port), information indicating the response to each of the issued queries, whether the result of all of the queries resulted in a success or failure, and the like. The failure statistics may also include information indicating the particular storage port, such as the WWPN (world wide port name), for which the failure statistics are related to.

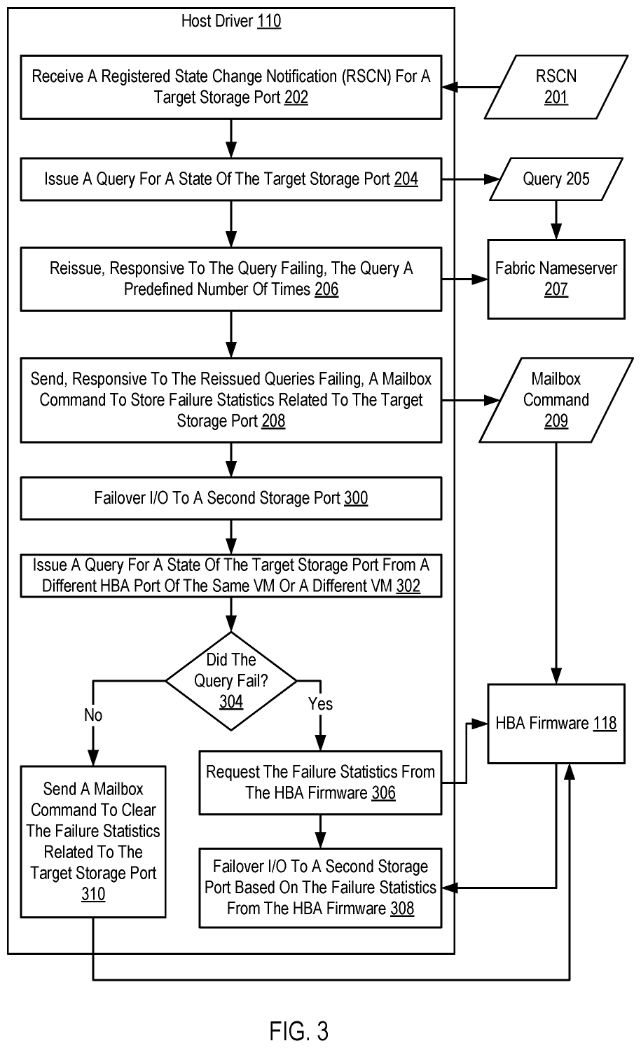

For further explanation, FIG. 3 sets forth a flowchart illustrating another example method of I/O failover according to embodiments of the present disclosure. The method of FIG. 3 includes failing over 300 I/O to a second storage port. Failing over 300 I/O may be carried out by the host driver 110 failing over the I/O from the target storage port to a second storage port on the SAN switch. Failing over the I/O may be carried out in response to the reissued queries failing. The second storage port may be any other storage port for accessing the same target storage device or address as the failed target storage port.

The method of FIG. 3 also includes issuing 302 a query for a state of the target storage port. Issuing 302 a query for a state of the target storage port may be carried out by the host driver 110 sending a query, such as a Fibre channel Common Transport Unit (CT_IU) called Get Port Identifier (GID_PN), to the Fabric Nameserver 207 within the FC fabric (not shown in FIG. 1). The query issued may be the same as query 205 in FIG. 2 and may be issued automatically in response to the host driver receiving an RSCN indicating the target storage port had a status change in order to obtain the status change information. For example, if a storage port is faulty due to a faulty cable, and therefore frequently connects and disconnects from the SAN, the host driver 110 may issue a query each time that an RSCN is sent in response to the storage port entering or leaving the SAN.

The method of FIG. 3 also includes determining 304 whether the issued query failed. Determining 304 whether the issued query failed is carried out by the host driver 110 based on the response to the query from the nameserver. For example, a query that failed is one which receives a query response indicating that the target storage port referred to in the query has not joined the SAN or does not join the SAN within a predetermined amount of time (according to a predetermined threshold). In contrast, a query that succeeds is one which gets a query response indicating that the storage port has successfully joined the SAN and provides an accessible I/O pathway.

The method of FIG. 3 also includes requesting 306 the failure statistics from the HBA firmware. Requesting 306 the failure statistics from the HBA firmware 118 may be carried out by the host driver 110 sending a mailbox command to the HBA firmware 118 in response to determining 304 that the query failed. The mailbox command sent to the HBA firmware may include instructions to send the stored failure statistics related to the target storage port to the host driver. In one embodiment, the mailbox command may have a ‘get’ bit enabled, indicating that the mailbox command is requesting the failure statistics currently stored in the HBA firmware for the target storage port. The HBA firmware may, in response to receiving the mailbox command requesting the failure statistics, send the failure statistics to the host driver 110.

The method of FIG. 3 also includes failing over 308 I/O to a second storage port based on the failure statistics from the HBA firmware. Failing over 308 I/O may be carried out by the host driver 110 failing over the I/O from the target storage port to a second storage port on the SAN switch. Failing over the I/O may be carried out based on the failure statistics received from the HBA firmware. Failing over the I/O may be carried out without reissuing the query or waiting a predetermined amount of time after determining that the target storage port has failed. The second storage port may be any other storage port for accessing the same target storage device or address as the failed target storage port. Failing over I/O to other storage ports without reissuing the query one or more times and waiting a predetermined amount of time each time an RSCN is received increases failover time and thereby increases computing performance and efficiency.

The method of FIG. 3 also includes sending 310 a mailbox command to clear the failure statistics related to the target storage port. Sending 310 the mailbox command may be carried out by the host driver 110 sending a mailbox command to the HBA firmware 118 in response to determining 304 that the query has not failed or is successful. The mailbox command sent to the HBA firmware may include instructions to send the stored failure statistics related to the target storage port to the host driver. In one embodiment, the mailbox command may have a ‘clear’ bit enabled, indicating that the mailbox command is requesting that HBA firmware clear or delete the failure statistics currently stored in the HBA firmware for the target storage port. The HBA firmware may, in response to receiving the mailbox command requesting the failure statistics, clear the failure statistics.

In the example method of FIG. 3, the steps of issuing 302 a query, determining 304 whether the issued query failed, requesting 306 the failure statistics from the HBA firmware, and sending 310 a mailbox command to clear the failure statistics all are depicted as being carried out by the same host driver 110 which previously went through the reissuing of the queries and instructing the HBA firmware to store failure statistics. In another embodiment, these steps may be carried out by another other host or host driver with access to the HBA 116 or HBA firmware 118. For example, in an N-port ID Virtualization (NPIV) environment, if one virtual machine 108 learns that a particular storage port is fault, the virtual machine may instruct the HBA firmware 118 to store failure statistics about the storage port, and then any virtual machine with access to the HBA 116 may access the failure statistics in order to more quickly failover I/O to other pathways using other storage ports compared to conventional methods, which require every host to go through the full process of waiting a predetermined amount of time before failing over to other pathways. In another embodiment, the method of FIG. 2 or FIG. 3 may be carried out during a boot process of the SAN, host, or virtual machines.

In view of the explanations set forth above, readers will recognize that the benefits of I/O failover using adapter firmware according to embodiments of the present disclosure include:
Increasing failover efficiency helps upper layers to drive the I/O fast without getting blocked or retried multiple times for each failover event.
Increasing failover efficiency in NPIV environments, where if one virtual machine on host 106 learns that a particular storage port is faulty, the failure information can be stored in HBA firmware and later accessed by any virtual machine on host 106 to failover to other I/O paths more quickly.
Improving the boot process by learning about faulty storage ports during the boot process and allowing for faster failover to alternative I/O paths through healthy storage ports to complete boot quickly.

The flowchart and block diagrams in the Figures illustrate the architecture, functionality, and operation of possible implementations of systems, methods, and apparatus according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Exemplary embodiments of the present disclosure are described largely in the context of a fully functional computer system for dynamic buffer selection in ethernet controllers. Readers of skill in the art will recognize, however, that the present disclosure also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present disclosure.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method of I/O failover, the method comprising:
receiving, by a host driver, a registered state change notification (RSCN) for a target storage port;
issuing, by the host driver, a query for a state of the target storage port;
reissuing, by the host driver and responsive to the query failing, the query a predefined number of times; and
sending, by the host driver to a host bus adapter (HBA) firmware and responsive to the reissued queries failing, a mailbox command to store failure statistics related to the target storage port.

2. The method of claim 1, further comprising failing over I/O to a second storage port.

3. The method of claim 1, wherein the mailbox command includes identity information for the target storage port, a number of query retries, and failure information.

4. The method of claim 1, further comprising:
issuing, after the failure statistics have been stored in the HBA firmware, the query for the state of the target storage port; and
requesting, by the host driver and responsive to the query failing, the failure statistics from the HBA firmware.

5. The method of claim 4, further comprising:
failing over, by the host driver and based on the failure statistics received from the HBA firmware, I/O to a second storage port without reissuing the query the predefined number of times.

6. The method of claim 1, further comprising:
issuing, after the failure statistics have been stored in the HBA firmware, the query for the state of the target storage port; and
sending, by the host driver and responsive to the query succeeding, a mailbox command to the HBA firmware to clear the failure statistics related to the target storage port.

7. The method of claim 1, wherein the host driver is included within a virtual machine.

8. The method of claim 7, wherein the virtual machine is one of a plurality of virtual machines accessing the target storage port via a N_Port ID Virtualization (NPIV) environment.

9. The method of claim 1, wherein each of receiving, issuing, reissuing, and sending are carried out during a storage area network (SAN) boot process.

10. A system for I/O failover, the system comprising:
a processor; and
computer memory comprising computer program instructions that, when executed cause the system to:
receive, by a host driver, a registered state change notification (RSCN) for a target storage port;
issue, by the host driver, a query for a state of the target storage port;
reissue, by the host driver and responsive to the query failing, the query a predefined number of times; and
send, by the host driver to a host bus adapter (HBA) firmware and responsive to the reissued queries failing, a mailbox command to store failure statistics related to the target storage port.

11. The system of claim 10, further comprising failing over I/O to a second storage port.

12. The system of claim 10, wherein the mailbox command includes identity information for the target storage port, a number of query retries, and failure information.

13. The system of claim 10, further comprising:
issuing, after the failure statistics have been stored in the HBA firmware, the query for the state of the target storage port; and
requesting, by the host driver and responsive to the query failing, the failure statistics from the HBA firmware.

14. The system of claim 13, further comprising:
failing over, by the host driver and based on the failure statistics received from the HBA firmware, I/O to a second storage port without reissuing the query the predefined number of times.

15. The system of claim 10, further comprising:
issuing, after the failure statistics have been stored in the HBA firmware, the query for the state of the target storage port; and
sending, by the host driver and responsive to the query succeeding, a mailbox command to the HBA firmware to clear the failure statistics related to the target storage port.

16. The system of claim 10, wherein the host driver is included within a virtual machine of a plurality of virtual machines accessing the target storage port via a N_Port ID Virtualization (NPIV) environment.

17. A computer program product for I/O failover, the computer program product comprising a non-volatile computer readable medium and computer program instructions stored therein that are configured to, when executed, cause a computer to perform operations comprising:
receiving, by a host driver, a registered state change notification (RSCN) for a target storage port;
issuing, by the host driver, a query for a state of the target storage port;
reissuing, by the host driver and responsive to the query failing, the query a predefined number of times; and
sending, by the host driver to a host bus adapter (HBA) firmware and responsive to the reissued queries failing, a mailbox command to store failure statistics related to the target storage port.

18. The computer program product of claim 17, further comprising:
issuing, after the failure statistics have been stored in the HBA firmware, the query for the state of the target storage port; and
requesting, by the host driver and responsive to the query failing, the failure statistics from the HBA firmware.

19. The computer program product of claim 18, further comprising:
failing over, by the host driver and based on the failure statistics received from the HBA firmware, I/O to a second storage port without reissuing the query the predefined number of times.

20. The computer program product of claim 17, further comprising:
issuing, after the failure statistics have been stored in the HBA firmware, the query for the state of the target storage port; and
sending, by the host driver and responsive to the query succeeding, a mailbox command to the HBA firmware to clear the failure statistics related to the target storage port.
